(19) United States
(12) Patent Application Publication
(10) Pub. No.: US 2019/0325021 A1
(43) Pub. Date: Oct. 24, 2019

(54) Method and Device for Creating Hyperlink

(71) Applicant: BEIJING DEEP INTELLIGENT PHARMA CO., LTD., Beijing (CN)

(72) Inventor: Min Zhang, Beijing (CN)

(73) Assignee: BEIJING DEEP INTELLIGENT PHARMA CO., LTD.

(21) Appl. No.: 16/113,139

(22) Filed: Aug. 27, 2018

(30) Foreign Application Priority Data
Apr. 20, 2018 (CN) 201810361300.0

(51) Int. Cl. G06F 17/27; G06F 17/30

(52) U.S. Cl. CPC G06F 17/278; G06F 17/30014; G06F 17/30882

(57) ABSTRACT

A method and device for creating a hyperlink are provided. The method includes: acquiring a target document including keyword information of a hyperlink to be created; analyzing the target document by natural-language processing and determining a keyword contained in the target document based on a standard keyword corpus; determining the keyword and qualifiers preceding and following the keyword as a target keyword and determining a target path of target contents corresponding to the target keyword; and creating a hyperlink by associating the target path to with the target keyword.

### CROSS REFERENCE TO RELATED APPLICATION

The present application claims the priority to Chinese Patent Application No. 201810:361300.0, titled “METHOD AND DEVICE FOR CREATING HYPERLINK”, filed on Apr. 20, 2018 with the State Intellectual Property Office of the PRC, which is incorporated herein by reference in its entirety.

### FIELD

The present disclosure relates to the technical field of document processing, and particularly to a method and device for creating a hyperlink.

### BACKGROUND

Presently, electronic documents are frequently used during work in various is fields. In order to understand some contents in an electronic document more deeply, hyperlinks may be created for some keywords in the electronic document, to link the keywords to relevant contents in the electronic document or other electronic document. A user may jump to contents relevant to the keywords for reading through the hyperlink.

In the conventional art, the user searches for a keyword for which a hyperlink is to he created in an electronic document, and creates a hyperlink based on the keyword and contents relevant to the keyword. For example, the user selects a keyword manually, clicks the option “insert” and clicks the option “hyperlink” to create a hyperlink as required.

It is found by the inventor by research that in the conventional art, it is necessary to manually position keywords for which hyperlinks are to he created, and create hyperlinks manually, and so on. The method for creating hyperlinks greatly depends on manpower, the operation process is complicated and consumes much manpower, thereby resulting in low work efficiency and a low automation degree, much time consumption, and a high probability of causing human errors,

### SUMMARY

The present disclosure is intended to provide a method and device for creating a hyperlink, so as to save manpower, reduce operation time, improve work efficiency and an automation degree, and improve an accuracy rate of hyperlink creation.

In a first aspect, a method for creating a hyperlink is provided in an embodiment of the present disclosure. The method includes: acquiring a target document including keyword information of a hyperlink to be created; analyzing the target document by natural-language processing and determining a keyword contained in the target document based on a standard keyword corpus; determining the keyword and qualifiers preceding and following the keyword as a target keyword and determining a target path of target contents corresponding to the target keyword; and creating a hyperlink by associating the target path with the target keyword.

In an embodiment, the process of analyzing the target document by natural-language processing and determining a keyword contained in the target document based on a standard keyword corpus includes: analyzing the target document by natural-language processing to acquire content information of the target document; and determining a keyword contained in the target document by matching the content information of the target document with the standard keyword corpus.

In an embodiment, the process of determining the keyword and qualifiers preceding and following the keyword as a target keyword and determining a target path of target contents corresponding to the target keyword includes: determining a set of contents corresponding to the keyword; setting the keyword and qualifiers preceding and following the keyword as a target keyword; determining target contents corresponding to the target keyword from the set of contents; and determining a target path of the target contents.

In an embodiment, the target contents are at least one of contents in the target document and contents in other document.

In an embodiment, the target document is an electronic common technical document for medicinal products.

In an embodiment, after the process of determining the target path of target contents corresponding to the target keyword, the method further includes: checking whether the target keyword corresponds to the target path, and creating a hyperlink by associating the target path with the target keyword in a case that the target keyword corresponds to the target path.

In an embodiment, the process of checking whether the target keyword corresponds to the target path includes: acquiring the target contents based on the target path; and determining whether the target contents are relevant to the target keyword.

In an embodiment, the target path includes key information of the target contents, and the process of checking whether the target keyword corresponds to the target path includes: determining whether the target keyword is relevant to the key information of the target contents.

In an embodiment, the method further includes: acquiring historical keywords including hyperlinks contained in a historical document, where the historical document is a historical electronic common technical document for medicinal products; and expanding the standard keyword corpus based on the historical keywords.

In a second aspect, a device for creating a hyperlink is provided in an embodiment of the present disclosure. The device includes: a first acquisition unit, a first determination unit, a second determination unit and a creation unit;

the first acquisition unit is configured to acquire a target document including keyword information of a hyperlink to be created;

the first determination unit is configured to analyze the target document by natural language processing and determine a keyword contained in the target document based on a standard keyword corpus;

the second determination unit is configured to determine the keyword and qualifiers preceding and following the keyword as a target keyword and determine a target path of target contents corresponding to the target keyword; and

the creation unit is configured to create a hyperlink by associating the target path with the target keyword.

Compared with the conventional art, the present disclosure has at least the following advantages.

With the technical solution described in the embodiments of the present disclosure, firstly, a target document including keyword information of a hyperlink to be created is acquired; secondly, the target document is analyzed by natural-language processing and a keyword contained in the target document is determined based on a standard keyword corpus; subsequently, the keyword and qualifiers preceding and following the keyword are determined as a target keyword and a target path of target contents corresponding to the target keyword is determined; and lastly, a hyperlink is created by associating the target path with the target keyword. In this way, the keyword for which a hyperlink is to be created is positioned automatically in the target document, the corresponding target path is determined, and the hyperlink for the target document is created automatically based on the target path and the target keyword. With this solution, manpower is saved and operation time is reduced, thereby improving work efficiency and an automation degree, and improving an accuracy rate of hyperlink creation.

### BRIEF DESCRIPTION OF THE DRAWINGS

In order to illustrate the technical solutions in embodiments of the present disclosure or in the conventional art more clearly, drawings to be used in the embodiments or in the conventional art will be briefly described hereinafter. Obviously, drawings in the following descriptions merely describe some of the embodiments of the present disclosure. Based on these drawings, those skilled in the art may obtain other drawings without any creative labors.

FIG. 1 is a schematic view illustrating a framework of a system involved in an application scenario according to an embodiment of the present disclosure;

FIG. 2 is a schematic flowchart of a method for creating a hyperlink according to an embodiment of the present disclosure; and

FIG. 3 is a schematic structural diagram of a device for creating a hyperlink according to an embodiment of the present disclosure.

### DETAILED DESCRIPTION OF EMBODIMENTS

In order to enable those skilled in the art to better understand technical solutions of the present disclosure, the technical solutions in the embodiments of the present disclosure will be described clearly and completely in conjunction with the drawings used in the embodiments hereinafter. Obviously, the embodiments to be described merely are a part rather than all of the embodiments of present disclosure. Any other embodiments obtained based on the embodiments in the present disclosure by those skilled in the art without any creative effort fall in the protection scope of the present disclosure.

It is found by the inventor by research that medical enterprises are required to submit a supervision request to the supervision mechanism by using a unified format of electronic common technical document (eCTD) for medicinal products. The eCTD format contains a large number of hyperlinks within and across documents, for facilitating reviewing of the supervision mechanism. In the conventional art, a hyperlink is created in the following manner. A user searches for a keyword for which a hyperlink is to be created in an electronic document, and creates a hyperlink based on the keyword and contents relevant to the keyword. For example, the user selects a keyword manually, clicks the option “insert” and clicks the option “hyperlink” to create a hyperlink as required. However, with the method in the conventional art, the keyword for which a hyperlink is to be created is positioned manually, the process for creating hyperlinks greatly depends on manpower, and the operation process is complicated, thereby resulting in low work efficiency and a low automation degree, much time consumption, and a high probability of causing human errors.

In order to solve the problem, in the embodiments of the preset disclosure, firstly, a target document including keyword information of a hyperlink to be created is acquired. Secondly, the target document is analyzed by natural-language processing and a keyword contained in the target document is determined based on a standard keyword corpus. Subsequently, the keyword and qualifiers preceding and following the keyword are determined as a target keyword, and a target path of target contents corresponding to the target keyword is determined. Lastly, a hyperlink is created by associating the target path with the target keyword. In this way, the keyword for which a hyperlink is to be created is positioned automatically in the target document, the corresponding target path is determined, and the hyperlink for the target document is created automatically based on the target path and the target keyword. With this solution, manpower is saved and operation time is reduced, thereby improving work efficiency and an automation degree, and improving an accuracy rate of hyperlink creation.

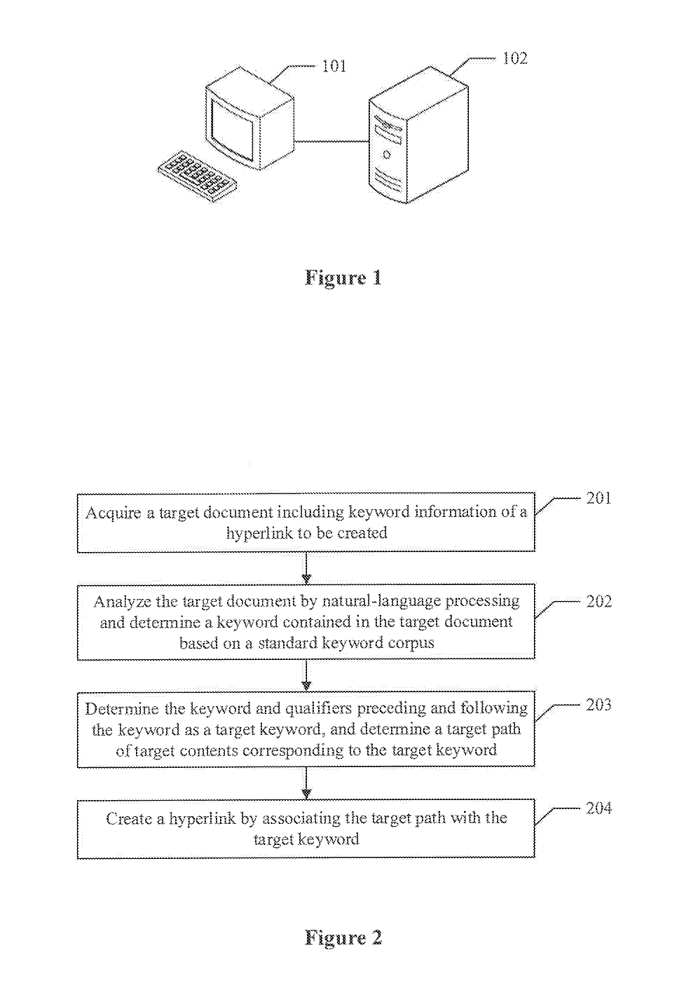

For example, one of the application scenarios in the embodiments of the present disclosure may be a scenario as shown in FIG. 1. The scenario includes a terminal 101 and a processor 102. A user transmits a set of eCTDs for medicinal products via the terminal 101, and selects one of the eCTDs for medicinal products as a target document to perform automatic creation of a hyperlink. In response to the creation, the processor 102 acquires a target document including keyword information of a hyperlink to be created; the processor 102 analyzes the target document by natural-language processing and determines a keyword contained in the target document based on a standard keyword corpus; the processor 102 determines the keyword and qualifiers preceding and following the keyword as a target keyword and determines a target path of target contents corresponding to the target keyword; the processor 102 creates a hyperlink by associating the target path with the target keyword; and the processor 102 stores the generated hyperlink in a database.

It should be understood that although the actions in the embodiment of the present disclosure are performed by the processor 102 in the above application scenario, the subject for performing the present disclosure is not limited, as long as the subject performs the actions disclosed in the embodiment of the present disclosure.

It should be understood that the application scenarios provided in the embodiments of the present disclosure include but are not limited to the above exemplary scenario.

Detailed implementations of the method and device for creating a hyperlink according to embodiments of the present disclosure will be described in detail hereinafter in conjunction with the drawings.

Exemplary Method

Reference is made to FIG. 2, which shows a schematic flowchart of a method for creating a hyperlink according to an embodiment of the present disclosure. In the present embodiment, the method includes, for example, steps 201 to 204.

In step 201, a target document including keyword information of a hyperlink to be created is acquired.

It should be noted that medical enterprises usually submits a supervision request to the supervision mechanism by using a whole set of eCTDs. In order to facilitate understanding some contents contained in the documents more deeply and reviewing some contents within the document or across the documents by the supervision mechanism, the eCTD generally contains a large number of hyperlinks within and across documents. Namely, the eCTD for medicinal products contains a large amount of keyword information of hyperlinks to be created. Therefore, the target document is an eCTD for medicinal products in some embodiments of the present disclosure.

In step 202, the target document is analyzed by natural-language processing and a keyword contained in the target document is determined based on a standard keyword corpus.

It should be noted that hyperlinks have to be created for some words in the eCTD for medicinal products according to requirements, stipulations or rules. These words may serve as standard keywords. Therefore, a corpus containing standard keywords may be pre-created. The target document contains a large amount of content information, which can be analyzed by nature-language processing. The method for determining a keyword contained in the target document from the large amount of content information includes: matching the analyzed content information of the target document with the pre-created corpus containing standard keywords. Therefore, in some implementations of the present embodiment, step 202 may include, for example, steps 2021 to 2022

In step 2021, the target document is analyzed by natural-language processing to acquire content information of the target document.

In step 2022, a keyword contained in the target document is determined by matching the content information of the target document with the standard keyword corpus.

It should be noted that the keywords contained in the standard keyword corpus are obtained based on words for which hyperlinks are to he created according to the requirements, stipulations or rules of the eCTD for medicinal products, and the number of the keywords is not large. In order to expand the standard keyword corpus, historical keywords including hyperlinks contained in a historical document may be also acquired. The standard keyword corpus may be expanded based on the historical keywords. The standard keyword corpus may be expanded directly based on the historical keywords, or based on a part of the historical keywords with a higher probability of appearing. Therefore, in some implementations of the embodiment, after a standard keyword corpus is pre-created , step 202 may include step A and step B, for example.

In Step A, historical keywords including hyperlinks contained in a historical document are acquired. The historical document is a historical eCTD for medicinal products.

In Step B, the standard keyword corpus is expanded based on the historical keywords.

In Step 203, the keyword and qualifiers preceding and following the keyword are determined as a target keyword, and a target path of target contents corresponding to the target keyword is determined.

It should be noted that the standard keywords contained in the standard keyword corpus in step 202 generally do not include qualifiers, i.e., the standard keyword corresponds to many relevant contents. For example, if the standard keyword is “table”, the corresponding relevant contents include “table 1”, “table 2”, . . . , “table n”, etc. Namely, there are many relevant contents corresponding to a keyword contained in the target document that is determined by matching with the standard keyword corpus in step 202. In order to determine a keyword for which a hyperlink to be actually created contained in the target document and the target contents corresponding to the keyword, target contents corresponding to the target keyword, which is composed of the keyword and qualifiers preceding and following the keyword, in the target document should be selected from the relevant contents corresponding to the keyword contained in the target document. Therefore, in some implementations of the embodiment, step 203 may include steps 2031 to 2034, for example.

In step 2031, a set of relevant contents corresponding to the keyword is determined.

in step 2032, the keyword and qualifiers preceding and following the keywords are set as a target keyword.

In step 2033, target contents corresponding to the target keyword are determined from the set of relevant contents.

In step 2034, a target path of the target contents is determined.

For example, if a set of relevant contents corresponding to the keyword “table” in the target document is {“table 1”, “table 2”, “table3”, “table 4”, “table 5”} and the qualifier preceding and following the keyword “table” in the target document is “3”, the target keyword is “table 3”, the corresponding target content is “table 3” in the set of relevant contents, and the corresponding target path is a storage path of “table 3”.

It should be understood that the target contents corresponding to a target keyword may be located at different positions in a same document or may be located in different documents. Therefore, in some implementations of the present embodiment, the target contents are contents in the target document and/or contents in other document.

It should be noted that due to various factors, such as a machine error, the target is path of target contents corresponding to the target keyword determined in step 203 is not necessarily correct. In order to improve an accuracy rate of hyperlink creation, step 204 is performed after it is determined that the target keyword really corresponds to the target path. Therefore, in some implementations of the embodiment, after Step 203, the method may, for example, further include: checking whether the target keyword corresponds to the target path, and performing step 204 in a case that the target keyword corresponds to the target path.

It should be noted that in some implementations of the present embodiment, it may be checked whether the target keyword corresponds to the target path in two manners. In a first manner, a page containing the target contents is opened based on the target path, and it is determined whether the target keyword corresponds to the target path based on correlation between the target contents and the target keyword. In a second manner, it is determined whether the target keyword corresponds to the target path based on correlation between the key information of the target contents contained in the target path and the target keyword. Detailed implementations are described as follows.

In a first implementation, the process of checking whether the target keyword corresponds to the target path may, for example, include;

acquiring the target contents based on the target path; and

determining whether the target contents are relevant to the target keyword.

In a second implementation, the target path includes key information of the target contents, and the checking whether the target keyword corresponds to the target path may, for example, include: determining whether the target keyword is relevant to the key information of the target contents.

In step 204: a hyperlink is created by associating the target path with the target keyword.

It should be noted that a hyperlink is created by directly associating the target path with the target keyword in step 204. However, in some implementations of the present embodiment, the target keyword may be stored together with the corresponding target path, until a hyperlink report including multiple target keywords-target paths is generated. Subsequently, the multiple target keywords and the corresponding target paths are imported in batches into the target document to create hyperlinks. In this way, multiple hyperlinks are created with one key operation, thereby reducing operation time, and improving work efficiency and an automation degree.

According to various implementations provided in the present embodiment, firstly, a target document including keyword information of a hyperlink to be created is acquired. Secondly, the target document is analyzed by natural-language processing and a keyword contained in the target document is determined based on a standard keyword corpus. Subsequently, the keyword and qualifiers preceding and following the keyword are determined as a target keyword and a target path of target contents corresponding to the target keyword is determined. Lastly, a hyperlink is created by associating the target path with the target keyword. In this way, the keyword for which a hyperlink is to be created is positioned automatically in the target document, the corresponding target path is determined, and the hyperlink for the target document is created automatically based on the target path and the target keyword. With this solution, manpower is saved and operation time is reduced, thereby improving work efficiency and an automation degree, and improving an accuracy rate of hyperlink creation.

Exemplary Apparatus

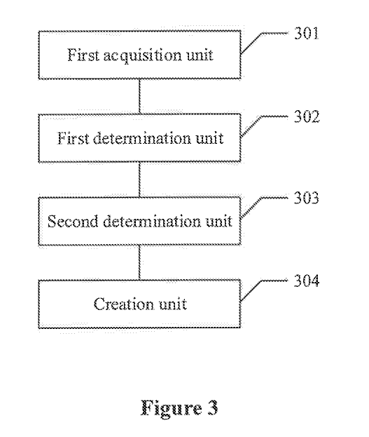

Reference is made to FIG. 3, which shows a schematic structural diagram of a device for creating a hyperlink according to an embodiment of the present disclosure. The device in the present embodiment may include a first acquisition unit 301, a first determination unit 302, a second determination unit 303 and a creation unit 304.

The first acquisition unit 301 is configured to acquire a target document including keyword information of a hyperlink to be created.

The first determination unit 302 is configured to analyze the target document by natural-language processing and determine a keyword contained in the target document based on a standard keyword corpus.

The second determination unit 303 is configured to determine the keyword arid qualifiers preceding and following the keyword as a target keyword and determine a target path of target contents corresponding to the target keyword.

The creation unit 304 is configured to create a hyperlink by associating the target path with the target keyword.

Optionally, the first determination unit 302 includes: a first acquisition subunit and a first determination subunit.

The first acquisition sub-unit is configured to analyze the target document by natural-language processing to acquire content information of the target document.

The first determination sub-unit is configured to determine a keyword contained in the target document by matching the content information of the target document with the standard keyword corpus.

Optionally, the second determination unit 303 includes: a second determination subunit, a setting unit, a third determining subunit and a fourth determining subunit.

The second determination sub-unit is configured to determine a set of relevant contents corresponding to the keyword.

The setting unit is configured to set the keyword and qualifiers preceding and following the keyword as a target keyword.

The third determination sub-unit is configured to determine target contents corresponding to the target keyword from the set of relevant contents.

The fourth determination sub-unit is configured to determine a target path of the target contents.

Optionally, the target contents are contents in the target document and/or contents in other document.

Optionally, the target document is an electronic common technical document for medicinal products.

Optionally, the device further includes: a checking unit.

The checking unit is configured to check whether the target keyword tip corresponds to the target path, and create a hyperlink by associating the target path with the target keyword in a case that the target keyword corresponds to the target path.

Optionally, the checking unit includes: a second acquisition subunit and a determination unit.

The second acquisition sub-unit is configured to acquire the target contents based on the target path.

The determination unit is configured to determine whether the target contents are relevant to the target keyword.

Optionally, the target path includes key information of the target contents, and the checking unit is configured to determine whether the target keyword is relevant to the key information of the target contents.

Optionally, the device further includes: an acquisition unit and an expansion unit.

The acquisition unit is configured to acquire historical keywords including hyperlinks contained in a historical document. The historical document is a historical eCTD for medicinal products.

The expansion unit is configured to expand the standard keyword corpus based on the historical keywords.

In the various implementations provided in the present embodiment, the first acquisition unit is configured to acquire a target document including keyword information of a hyperlink to be created. The first determination unit is configured to analyze the target document by natural-language processing and determine a keyword contained in the target document based on a standard keyword corpus. The second determination unit is configured to determine the keyword and qualifiers preceding and following the keyword as a target keyword and determine a target path of target contents corresponding to the target keyword. The creation unit is configured to create a hyperlink by associating the target path with the target keyword. In this way, the keyword for which a hyperlink is to be created is positioned automatically in the target document, the corresponding target path is determined, and the hyperlink for the target document is created automatically based on the target path and the target keyword. With this solution, manpower is saved and operation time is reduced, thereby improving work efficiency and an automation degree, and improving an accuracy rate of hyperlink creation.

The embodiments in the specification are described in a progressive manner. Each embodiment emphasizes differences from other embodiments. Similar parts of the embodiments may be referenced by each other. The apparatus disclosed in the embodiments is described simply because the apparatus corresponds to the method disclosed in the embodiments. For the relevant parts, one may refer to the part of the description of the method.

A person skilled in the art may further realize that the units and algorithm steps described in the embodiments in the present disclosure can be performed by electronic hardware, computer software or a combination thereof. In order to clearly explain interchangeability between the hardware and software, the components and steps in the embodiments are generally described on the basis of the functions above. Whether the functions are performed by hardware or software depends on specific applications of the technical solution and constraint conditions for design. The person skilled in the art can perform the described functions for each specific application using different methods, but the performance shall not be deemed as going beyond the scope of the present disclosure.

It should be noted that the relation terms, such as first and second, are merely used for distinguishing an entity or operation from another entity or operation, but the relation terms do not necessarily require or imply that any actual relationship or sequence exists between the entities or operations. The terms, such as “comprise”, “contain” or any other variation, are inclusive, so that a process, method, article or device including a series of elements, not only includes the elements, but also includes other elements that are not listed clearly or elements inherent for the process, method, article or device. In case of no more limitations, elements limited by “comprising a . . . ” do not exclude that other identical elements exist in the process, method, article or device including the elements.

Preferred embodiments of the present disclosure are described above, but they do not limit the scope of the present disclosure in any form. Although the present disclosure is disclosed above with the preferred embodiments, the preferred embodiments are not intended to limit the scope of the present disclosure. Any person skilled in the art can make many possible variations and modifications to the technical solutions of the present disclosure by using the disclosed method or technical contents without departing from the scope of the technical solution of the present disclosure, or amend the technical solution of the present disclosure into equivalent embodiments with equivalent changes. Therefore, any simple amendments, equivalent changes and modifications made to the above embodiments according to the technical essence of the present disclosure without departing from the scope of the technical solution of the present disclosure, shall fall within the protection scope of the technical solution of the present disclosure.

1. A method for creating a hyperlink, comprising:
acquiring a target document comprising keyword information of a hyperlink to be created;
analyzing the target document by natural-language processing and determining a keyword contained in the target document based on a standard keyword corpus;
determining the keyword and qualifiers preceding and following the keyword as a target keyword and determining a target path of target contents corresponding to the target keyword; and
creating a hyperlink by associating the target path with the target keyword.

2. The method according to claim 1, wherein the analyzing the target document by natural-language processing and determining a keyword contained in the target document based on a standard keyword corpus comprises:
analyzing the target document by natural-language processing to acquire content information of the target document; and
determining the keyword contained in the target document by matching the content information of the target document with the standard keyword corpus.

3. The method according to claim 1, wherein the determining the keyword and qualifiers preceding and following the keyword as a target keyword and determining a target path of target contents corresponding to the target keyword comprises:
determining a set of contents corresponding to the keyword;
setting the keyword and qualifiers preceding and following the keyword as a target keyword;
determining target contents corresponding to the target keyword from the set of contents; and
determining a target path of the target contents.

4. The method according to claim 1, wherein the target contents are at least one of contents in the target document and contents in other document.

5. The method according to claim 1, wherein the target document is an electronic common technical document for medicinal products.

6. The method according to claim 1, wherein after the determining the target path of target contents corresponding to the target keyword, the method further comprises:
checking whether the target keyword corresponds to the target path, and creating a hyperlink by associating the target path with the target keyword in a case that the target keyword corresponds to the target path.

7. The method according to claim 6, wherein the checking whether the target keyword corresponds to the target path comprises:
acquiring the target contents based on the target path; and
determining whether the target contents are relevant to the target keyword.

8. The method according to claim 6, wherein the target path comprises key information of the target contents, and the checking whether the target keyword corresponds to the target path comprises:
determining whether the target keyword is relevant to the key information of the target contents.

9. The method according to claim 1, further comprising:
acquiring historical keywords comprising hyperlinks contained in a historical document, wherein the historical document is a historical electronic common technical document for medicinal products; and
expanding the standard keyword corpus based on the historical keywords.

10. A device for creating a hyperlink, comprising:
a first acquisition unit configured to acquire a target document comprising keyword information of a hyperlink to be created;
a first determination unit configured to analyze the target document by natural-language processing and determine a keyword contained in the target document based on a standard keyword corpus;
a second determination unit configured to determine the keyword and qualifiers preceding and following the keyword as a target keyword and determine a target path of target contents corresponding to the target keyword; and
a creation unit configured to create a hyperlink by associating the target path with the target keyword.
